(19) United States
(12) Patent Application Publication
(10) Pub. No.: US 2026/0309030 A1
(43) Pub. Date: Oct. 8, 2026

(54) DISC OF ROTATING MACHINE, AND ROTATING MACHINE

(71) Applicant: MITSUBISHI HEAVY INDUSTRIES, LTD., Tokyo (JP)

(72) Inventors: Ryogo HISHIKAWA, Tokyo (JP); Toshihiro TAKEDA, Tokyo (JP); Tomoto NAGAI, Tokyo (JP)

(73) Assignee: MITSUBISHI HEAVY INDUSTRIES, LTD., Tokyo (JP)

(21) Appl. No.: 18/998,408

(22) PCT Filed: Feb. 17, 2023
(86) PCT No.: PCT/JP2023/005852

§ 371 Date: Jan. 24, 2025

(30) Foreign Application Priority Data
Jul. 27, 2022 (JP) 2022-119636

(51) Int. Cl. F01D 5/02

(52) U.S. Cl. CPC F01D 5/02; F05D 2300/603

(57) ABSTRACT

A disc of a rotating machine according to the present disclosure includes: an inner diameter-side member configured to have an annular shape centered on an axis line, to form a portion on a radial inner side with respect to the axis line, and to be formed of a first material having relatively high density and relatively high stiffness; and an outer diameter-side member configured to be joined to a radial outer side of the inner diameter-side member, and to be formed of a second material having relatively low density and relatively high stiffness.

### TECHNICAL FIELD

The present disclosure relates to a disc of a rotating machine, and a rotating machine.

Priority is claimed on Japanese Patent Application No. 2022-119636, filed Jul. 27, 2022, the content of which is incorporated herein by reference.

### BACKGROUND ART

A turbofan engine, which is a type of rotating machine, includes a turbofan, a compressor, a combustor, and a turbine. Among these, a fan blade of the turbofan, a rotor blade of the compressor, and a rotor blade of the turbine are joined to a shaft extending along an axis line and rotate around the axis line together with the shaft. The turbofan is joined to the shaft via a member called a disc. The disc has an annular shape centered on the axis line.

As a technology for joining the fan blade to the disc, for example, the technology described in Patent Document 1 described below is known. In this technology, a plurality of protrusions that mesh with each other are formed on a base end of a first member corresponding to a fan blade and an outer peripheral surface of a second member corresponding to a disc by three-dimensional additive manufacturing.

Accordingly, the first member is joined to the second member.

### CITATION LIST

### Patent Document

Patent Document 1: Japanese Unexamined Patent Application, First Publication No. 2017-82773

### SUMMARY OF INVENTION

### Technical Problem

However, in a case where members are mechanically joined to each other by a complex structure formed by the three-dimensional additive manufacturing as described above, there is a concern that weight reduction may be hindered by a member required at a joining location.

The present disclosure has been made in order to solve the above-described problems, and an object of the present disclosure is to provide a disc of a rotating machine and a rotating machine, each of which has a lighter structure.

### Solution to Problem

In order to solve the above-described problem, a disc of a rotating machine according to the present disclosure includes: an inner diameter-side member that has an annular shape centered on an axis line, that forms a portion of the disc on a radial inner side relative to the axis line, and that is formed of a first material having high density and high stiffness in the disc; and an outer diameter-side member that is joined to a radial outer side with respect to the inner diameter-side member, and that is formed of a second material having low density and high stiffness in the disc.

A disc of a rotating machine according to the present disclosure includes: an inner diameter-side member that has an annular shape centered on an axis line, that forms a portion of the disc on a radial inner side with relative to the axis line, and that is formed of a third material having low density and low stiffness in the disc; and an outer diameter-side member that forms a portion of the disc on a radial outer side, and that is formed of a fourth material having high density and high stiffness in the disc.

A rotating machine according to the present disclosure includes: the disc of a rotating machine described above; a plurality of blades configured to extend toward a radial outer side from the disc of the rotating machine, and to be arranged in a circumferential direction; and a casing configured to cover the blades from an outer periphery side.

### Advantageous Effects of Invention

According to the present disclosure, it is possible to provide a disc of a rotating machine and a rotating machine, each of which has a lighter structure.

### BRIEF DESCRIPTION OF DRAWINGS

FIG. 1 A schematic sectional view showing the configuration of a turbofan engine as a rotating machine according to a first embodiment of the present disclosure.

FIG. 2 A sectional view showing configurations of a fan blade and a disc according to the first embodiment of the present disclosure.

FIG. 3 A sectional view of the disc according to the first embodiment of the present disclosure, which is a sectional view taken along line III-III of FIG. 2.

FIG. 4 A sectional view of a disc according to a second embodiment of the present disclosure.

FIG. 5 A sectional view of a disc according to a third embodiment of the present disclosure.

FIG. 6 A sectional view of the disc according to the third embodiment of the present disclosure as viewed from a direction of an axis line.

FIG. 7 A sectional view in the direction of the axis line, showing a first modification example of the disc according to the third embodiment of the present disclosure.

FIG. 8 A sectional view in the direction of the axis line, showing a second modification example of the disc according to the third embodiment of the present disclosure.

### DESCRIPTION OF EMBODIMENTS

### First Embodiment

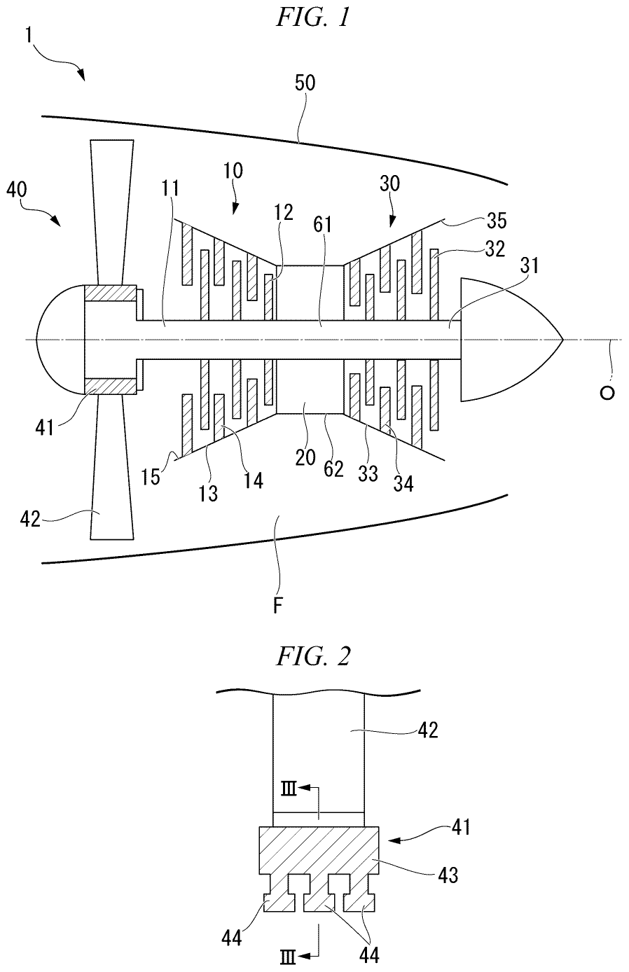

Hereinafter, configurations of a turbofan engine 1 as a rotating machine and a disc 41 as a disc 41 of a rotating machine according to a first embodiment of the present disclosure will be described with reference to FIGS. 1 to 3.

### Configuration of Turbofan Engine

The turbofan engine 1 is mounted on, for example, an aircraft and functions as a thrust device. As shown in FIG. 1, the turbofan engine 1 includes a compressor 10, a combustor 20, a turbine 30, a turbofan 40, and a duct 50.

The compressor 10 compresses external air to generate high-pressure compressed air. The compressor 10 includes a compressor rotor 11, a compressor rotor blade 12, a compressor casing 13, and a compressor stator vane 14. The compressor rotor 11 has a columnar shape extending along an axis line O. The compressor rotor 11 is supported by a bearing device (not shown) to be rotatable around the axis line O. A plurality of compressor rotor blades 12 that extend to a radial outer side and are arranged at intervals in a circumferential direction are provided on an outer peripheral surface of the compressor rotor 11. A plurality of rows of the compressor rotor blades 12 are provided at intervals in a direction of the axis line O.

The compressor casing 13 has a tubular shape that covers the compressor rotor 11 and the compressor rotor blades 12 from an outer periphery side. A plurality of compressor stator vanes 14 that extend to a radial inner side and are arranged at intervals in the circumferential direction are provided on an inner peripheral surface of the compressor casing 13. A plurality of rows of the compressor stator vanes 14 are provided at intervals in the direction of the axis line O. In addition, the rows of the compressor stator vanes 14 and the rows of the compressor rotor blades 12 are arranged alternately in the direction of the axis line O. The compressor casing 13 is provided with an intake port 15 for taking in air flowing in from one side in the direction of the axis line O. In the following description, a direction in which air flows away from the intake port 15 is referred to as a downstream side, and the opposite side is referred to as an upstream side.

The combustor 20 is provided on the downstream side of the compressor casing 13. The combustor 20 generates a high-temperature and high-pressure combustion gas by mixing fuel with the compressed air generated by the compressor 10 and combusting the mixture. The combustor 20 is provided between the compressor casing 13 and a turbine casing 33 (described later). Although not shown in detail, an annular type, a can type, or a cannular type is suitably used as the combustor 20.

The turbine 30 is rotationally driven by the combustion gas generated by the combustor 20 to pump air toward the downstream side and generate at least a part of the thrust. The turbine 30 includes a turbine rotor 31, a turbine rotor blade 32, the turbine casing 33, and a turbine stator vane 34. The turbine rotor 31 has a columnar shape extending along the axis line O. That is, the turbine rotor 31 is disposed coaxially with the compressor rotor 11 described above. A plurality of turbine rotor blades 32 that extend toward the radial outer side and are arranged at intervals in the circumferential direction are provided on an outer peripheral surface of the turbine rotor 31. A plurality of rows of the turbine rotor blades 32 are provided at intervals in the direction of the axis line O.

The turbine casing 33 has a tubular shape that covers the turbine rotor 31 and the turbine rotor blades 32 from the outer periphery side. A plurality of turbine stator vanes 34 that extend to the radial inner side and are arranged at intervals in the circumferential direction are provided on an inner peripheral surface of the turbine casing 33. A plurality of rows of the turbine stator vanes 34 are provided at intervals in the direction of the axis line O. In addition, the rows of the turbine stator vanes 34 and the rows of the turbine rotor blades 32 are arranged alternately in the direction of the axis line O. An exhaust port 35 for discharging the exhaust air pumped by the turbine 30 toward the downstream side is formed on the downstream side of the turbine casing 33.

The compressor rotor 11 and the turbine rotor 31 are coaxially connected on the axis line O to form a rotor 61. The compressor casing 13 and the turbine casing 33 are integrally connected to each other with the axis line O as a center to form a casing 62. That is, the rotor 61 is rotatable around the axis line O inside the casing 62.

The turbofan 40 is mounted on an end portion on the upstream side of the rotor 61. The turbofan 40 is provided to supply air to an inner region of the casing 62 described above and an outer region of the casing 62 (a bypass flow path F partitioned by the duct 50 (described later)). The turbofan 40 includes the disc 41 fixed to a tip of the rotor 61, and a plurality of fan blades 42 that extend toward the radial outer side from an outer peripheral surface of the disc 41 and are arranged at intervals in the circumferential direction.

The disc 41 has an annular shape centered on the axis line O. As shown in FIG. 2, the disc 41 has a disc main body 43 having a cylindrical shape centered on the axis line O, and a plurality of ribs 44 that protrude from the disc main body 43 toward the radial inner side and are arranged at intervals in the direction of the axis line O. One of the ribs 44 is fixed to the rotor 61 described above, so that the disc 41 is rotated around the axis line O together with the rotor 61. The fan blade 42 is mounted on an outer peripheral surface of the disc main body 43. The fan blade 42 is formed of, for example, a composite material such as CFRP or GFRP. In addition, the outer diameter of the fan blade 42 is set to be larger than the outer diameter of the casing 62.

The duct 50 covers the fan blade 42 and the casing 62 from the outer periphery side. The duct 50 has a tubular shape centered on the axis line O. In the space formed inside the duct 50, a space formed between the inner peripheral surface of the duct 50 and the outer peripheral surface of the casing 62 serves as the bypass flow path F.

In driving the turbofan engine 1, the rotor 61 is rotationally driven around the axis line O by an electric motor or the like. Then, the compressor 10 generates compressed air and sends the compressed air to the combustor 20. The combustor 20 mixes fuel with the compressed air and combusts the mixture to generate a high-temperature and high-pressure combustion gas. The combustion gas comes into contact with the turbine rotor blades 32, and thus a rotational force around the axis line O is applied to the rotor 61 via the turbine rotor blades 32. This rotational force is also transmitted to the compressor 10 through the rotor 61 and also serves as a driving force of the compressor 10. In addition, the turbofan 40 is also rotationally driven integrally with the rotor 61 to send external air to the bypass flow path F and the compressor 10.

The turbofan engine 1 is operated by continuously generating such cycles.

### Configuration of Disc

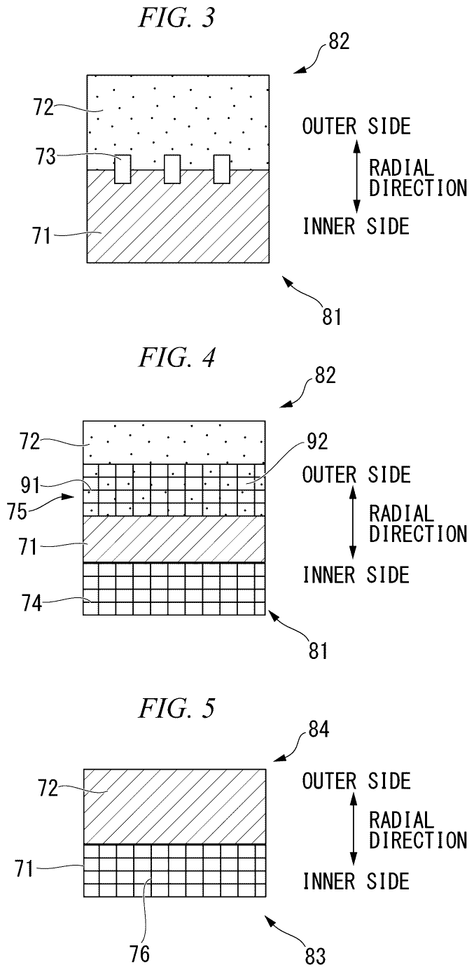

Subsequently, a detailed configuration of the disc 41 will be described with reference to FIG. 3. The disc 41 includes an inner diameter-side member 71, an outer diameter-side member 72, and a joint 73. The inner diameter-side member 71 forms a portion on a radial inner side of the disc 41 having an annular shape. Specifically, the inner diameter-side member 71 occupies a range of 10% to 70% of the radial dimension of the disc 41. It is more desirable that the inner diameter-side member 71 occupies a range of 10% to 50% of the radial dimension of the disc 41. The inner diameter-side member 71 is formed of a first material 81. Specifically, a solid metal material such as an aluminum alloy is used as the first material 81. That is, the first material 81 has high density and high stiffness.

The outer diameter-side member 72 is joined to an outer periphery side of the inner diameter-side member 71 via the joint 73. The outer diameter-side member 72 forms a portion a radial outer side of the disc 41. The outer diameter-side member 72 occupies a range of 30% to 90% of the radial dimension of the disc 41. It is more desirable that the outer diameter-side member 72 occupies a range of 50% to 90% of the radial dimension of the disc 41. The outer diameter-side member 72 is formed of a second material 82. The second material 82 is a composite material. More specifically, a carbon fiber reinforced plastics (CFRP), a glass fiber reinforced plastics (GFRP), or a ceramics matrix composite (CMC) is suitably used as the second material 82. That is, in the second material 82, a composite material in which a resin serving as a base material is impregnated and cured in carbon fibers or glass fibers is used. In addition, it is also possible to use other composite materials as the second material 82. The second material 82 has lower density than the first material 81, but has a stiffness that is as high as that of the first material 81.

The joint 73 joins the inner diameter-side member 71 and the outer diameter-side member 72 to each other. As the joint 73, specifically, a joint by welding, a joint by frictional bonding, or a joint by nano-molding bonding can be given.

### Operation and Effect

Here, in the turbofan engine 1 that is used as an aircraft engine, it is required to reduce the weight of each member and increase the strength of each member in order to achieve both improvement of the range performance and the fuel consumption rate and improvement of the reliability. However, in a case of an annular member that is rotationally driven, such as the disc 41 described above, circumferential stress tends to increase toward an inner periphery side and decrease toward an outer periphery side.

According to the above-described configuration, the portion on the radial inner side where larger circumferential stress is generated in a case where a rotational force is applied is formed of the first material 81 having high density, high stiffness, and high strength reliability. Accordingly, it is possible to sufficiently resist the circumferential stress. On the other hand, the portion on the radial outer side where circumferential stress is relatively small is formed of the second material 82 having low density and high stiffness. Accordingly, a density gradient is formed in the radial direction, so that it is possible to make the portion have necessary and sufficient strength according to the radial position. Therefore, for example, it is possible to reduce a portion where the strength is unnecessarily high and the weight is excessive, compared to a case where the disc 41 is integrally formed of a single material. As a result, it is possible to achieve sufficient weight reduction while maintaining the required strength of the entire disc 41. Further, since securing of the above-described stiffness and the weight reduction can be realized without increasing the number of components, the possibility of an increase in weight or an increase in failure risk due to the use of additional components can also be reduced.

Further, according to the above-described configuration, by using a metal material such as an aluminum alloy as the first material 81 on the radial inner side, it is possible to easily secure the required strength, and by using a composite material as the second material 82 on the radial outer side, it is possible to easily achieve a reduction in density, that is, a reduction in weight. Accordingly, since the centrifugal force caused by the outer diameter-side member 72 can be reduced, a load that is applied to the inner diameter-side member 71 in a superimposed manner can also be reduced. Therefore, the reliability of the disc 41 can be further increased. In addition, since the composite material has high strength stiffness and also has excellent vibration characteristics, it is possible to realize vibration reduction of the entire disc 41. In addition, by changing the aligning properties of the fiber material, anisotropy can be imparted to the composite material, and thus the weight can be reduced to the maximum extent while ensuring the required stress tolerance. That is, it is possible to precisely control the density gradient even inside the outer diameter-side member 72. Accordingly, the strength design is optimized, and further weight reduction can be realized.

The first embodiment of the present disclosure has been described above. Various changes and modifications can be made to the above configuration without departing from the gist of the present disclosure.

### Second Embodiment

Next, a second embodiment of the present disclosure will be described with reference to FIG. 4. In addition, the same components as those in the first embodiment are denoted by the same reference numerals, and a detailed description thereof will be omitted. As shown in FIG. 4, the disc 41 according to the present embodiment further includes an inner diameter-side lattice structure 74 and a joining portion 75, in addition to the inner diameter-side member 71 and the outer diameter-side member 72 described in the first embodiment.

The inner diameter-side lattice structure 74 is provided further on the radial inner side of the inner diameter-side member 71. The inner diameter-side lattice structure 74 has a plurality of beams extending at least in the circumferential direction and the radial direction. The end portions of these beams are connected to each other, so that a lattice structure is formed. Since the inner diameter-side lattice structure 74 has low density, the inner diameter-side lattice structure 74 is lighter than a solid metal material that forms the inner diameter-side member 71. In addition, the inner diameter-side lattice structure 74 has lower stiffness than the inner diameter-side member 71. Further, it is desirable that the inner diameter-side lattice structure 74 is formed integrally with the inner diameter-side member 71 by three-dimensional additive manufacturing.

The joining portion 75 is provided to join the inner diameter-side member 71 and the outer diameter-side member 72 in the radial direction. The joining portion 75 includes an intermediate lattice structure 91 and a base material for joining 92. The intermediate lattice structure 91 has the same configuration as the inner diameter-side lattice structure 74 described above. The intermediate lattice structure 91 is integrally formed on the outer peripheral surface of the inner diameter-side member 71. Three-dimensional additive manufacturing is suitably used for forming the intermediate lattice structure 91. The base material for joining 92 is a member made of only a base material, which is impregnated with fibers, in the composite material forming the outer diameter-side member 72. That is, the voids formed between the beams of the intermediate lattice structure 91 are impregnated with the base material, whereby the intermediate lattice structure 91 and the base material for joining 92 are joined to each other.

### Operation and Effect

According to the above-described configuration, the inner diameter-side lattice structure 74 having low density and low stiffness is provided, so that in a case where a rotational force is applied, the inner diameter-side lattice structure 74 is preferentially deformed. Therefore, the circumferential stress that is borne by the inner diameter-side lattice structure 74 is reduced. Accordingly, the distribution of the circumferential stress in the radial direction is made uniform. As a result, for example, a portion where the unnecessary strength stiffness is high and the weight is excessive can be reduced compared to a case where the disc 41 is integrally formed of a single material. Accordingly, it is possible to reduce the weight of the entire disc 41.

Further, according to the above-described configuration, the inner diameter-side member 71 and the outer diameter-side member 72 are joined to each other by the joining portion 75. The joining portion 75 is composed of the intermediate lattice structure 91 that is formed integrally with the inner diameter-side member 71 and a base material of a part of the composite material impregnated in the intermediate lattice structure 91. Accordingly, the inner diameter-side member 71 and the outer diameter-side member 72 can be more firmly joined to each other compared to a case where another mechanical bonding method is adopted. In addition, since the reliability of the joining is high, the inspection frequency can also be reduced. Accordingly, it is also possible to realize a reduction in maintenance cost.

The second embodiment of the present disclosure has been described above. Various changes and modifications can be made to the above configuration without departing from the gist of the present disclosure.

### Third Embodiment

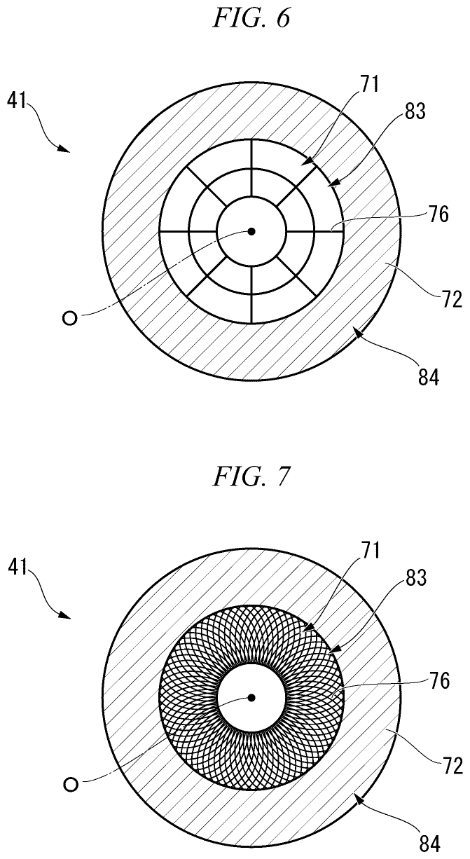

Subsequently, a third embodiment of the present disclosure will be described with reference to FIGS. 5 and 6. In addition, the same configures as those in each of the embodiments described above are denoted by the same reference signs, and detailed descriptions thereof will be omitted. As shown in FIG. 5 or FIG. 6, in the disc 41 according to the present embodiment, the materials forming the inner diameter-side member 71 and the outer diameter-side member 72 are different from those in each of the above-described embodiments.

The inner diameter-side member 71 is formed of a third material 83. The third material 83 is a lattice structure 76. The lattice structure 76 has the same configuration as the inner diameter-side lattice structure 74 described above. That is, the lattice structure 76 has a plurality of beams extending at least in the circumferential direction and the radial direction. The outer diameter-side member 72 is formed of a fourth material 84. Specifically, the fourth material 84 is a solid metal material such as an aluminum alloy. Therefore, the third material 83 has relatively low density and low stiffness as compared with the fourth material 84. On the contrary, the fourth material 84 has relatively high density and high stiffness as compared with the third material 83. The inner diameter-side member 71 and the outer diameter-side member 72 are integrally formed of the same material. That is, the third material 83 and the fourth material 84 are formed of the same material (the above-described aluminum alloy or the like). It is desirable to use three-dimensional additive manufacturing in creating the inner diameter-side member 71 and the outer diameter-side member 72. The inner diameter-side member 71 and the outer diameter-side member 72 may be formed of different materials.

### Operation and Effect

According to the above-described configuration, the inner diameter-side member 71 formed of the third material 83 having low density and low stiffness is provided, so that the inner diameter-side member 71 is likely to be deformed preferentially in a case where a rotational force is applied. Therefore, the circumferential stress that is borne by the inner diameter-side member 71 is reduced. Accordingly, the distribution of the circumferential stress in the radial direction is made uniform. As a result, for example, a portion where the unnecessary strength stiffness is high and the weight is excessive can be reduced compared to a case where the disc 41 is integrally formed of a single material. Accordingly, it is possible to reduce the weight of the entire disc 41.

Further, according to the above-described configuration, by using the lattice structure 76 as the third material 83, a large number of voids are formed by the plurality of beams, and thus it is possible to easily realize a reduction in density and a reduction in stiffness of the inner diameter-side member 71. Accordingly, the weight of the inner diameter-side member 71 can be reduced. In addition, by using a solid metal material as the fourth material 84, it is possible to easily realize an increase in density and an increase in stiffness of the outer diameter-side member 72, as compared with the inner diameter-side member 71.

The third embodiment of the present disclosure has been described above. Various changes and modifications can be made to the above configuration without departing from the gist of the present disclosure.

For example, as shown in FIG. 7 as a first modification example, a direction in which the beam of the lattice structure 76 extends can be changed. In the example of FIG. 7, one beam has a shape that extends in the radial direction and is curved to be convex in the circumferential direction at a central portion in the radial direction. The lattice structure 76 is formed by disposing such beams to be continuous in the circumferential direction and to be connected to each other. Even with such a configuration, the same effects as those described above can be obtained.

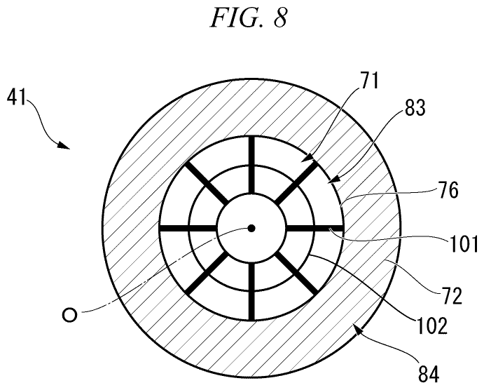

In addition, as shown in FIG. 8 as a second modification example, it is also possible to change the thickness (diameter) of some of the beams of the lattice structure 76. In the example of FIG. 8, the thickness of the beam (a radial beam 101) extending in the radial direction is made larger than the thickness of the beam (a circumferential beam 102) extending in the circumferential direction. In this manner, by varying the thickness of the beam according to the direction, anisotropy can be imparted to the structural strength of the lattice structure 76. That is, it is possible to arbitrarily change and optimize the stress distribution of the lattice structure 76. Accordingly, the strength design of the disc 41 can be further optimized.

### Additional Remark

The disc 41 of a rotating machine and the rotating machine described in each embodiment are understood as follows, for example.
(1) A disc 41 of a rotating machine according to a first aspect includes: the inner diameter-side member 71 that has an annular shape centered on the axis line O, and that forms a portion of the disc 41 on a radial inner side relative to the axis line O, and that is formed of the first material 81 having relatively high density and relatively high stiffness in the disc 41; and the outer diameter-side member 72 that is joined to a radial outer side with respect to the inner diameter-side member 71 and that is formed of the second material 82 having relatively low density and relatively high stiffness in the disc 41.

According to the above configuration, the portion on the radial inner side where larger circumferential stress is generated when a rotational force is applied is formed of the first material 81 having high density and high stiffness and having high strength reliability. Accordingly, it is possible to sufficiently resist the circumferential stress. On the other hand, the portion on the radial outer side where circumferential stress is relatively small is formed of the second material 82 having low density and high stiffness. Accordingly, it is possible to reduce the weight while maintaining the stiffness.
(2) A disc 41 of a rotating machine according to a second aspect is the disc 41 of a rotating machine according to the first aspect, in which the first material 81 is a metal material, and the second material 82 is a composite material having a fiber material and a base material impregnated with the fiber material.

According to the above configuration, by using the metal material as the first material 81 on the radial inner side, high stiffness can be ensured, and by using the composite material as the second material 82 on the radial outer side, a reduction in density, that is, a reduction in weight can be achieved. In addition, since the composite material has excellent vibration characteristics, it is also possible to realize the reduction of vibration of the entire disc 41 of a rotating machine. In addition, by changing the aligning properties of the fiber material, anisotropy can be imparted to the composite material, and thus the weight can be reduced to the maximum extent while ensuring the required stress tolerance.
(3) A disc 41 of a rotating machine according to a third aspect is the disc 41 of a rotating machine according to the first or second aspect, further including: the inner diameter-side lattice structure 74 that is joined further to the radial inner side of the inner diameter-side member 71 and that includes a plurality of beams extending at least in the radial direction and the circumferential direction.

According to the above-described configuration, the inner diameter-side lattice structure 74 having low density and low stiffness is provided, so that in a case where a rotational force is applied, the inner diameter-side lattice structure 74 is preferentially deformed. Therefore, the circumferential stress that is borne by the inner diameter-side lattice structure 74 is reduced. Accordingly, the distribution of the circumferential stress in the radial direction is made uniform, and it is possible to reduce the weight of the entire disc 41 of a rotating machine.
(4) A disc 41 of a rotating machine according to a fourth aspect is the disc 41 of a rotating machine according to the second or third aspect, further including: the joining portion 75 that joins the inner diameter-side member 71 and the outer diameter-side member 72 to each other, in which the joining portion 75 includes the intermediate lattice structure 91 that has a plurality of beams extending at least in the radial direction and the circumferential direction, and that is integrally joined to the inner diameter-side member 71, and the base material for joining 92 that is formed of the base material of the composite material forming the outer diameter-side member 72, and that fills voids in the intermediate lattice structure 91.

According to the above configuration, the inner diameter-side member 71 and the outer diameter-side member 72 are joined to each other by the joining portion 75. The joining portion 75 is composed of the intermediate lattice structure 91 that is formed integrally with the inner diameter-side member 71 and a base material of a part of the composite material impregnated in the intermediate lattice structure 91. Accordingly, the inner diameter-side member 71 and the outer diameter-side member 72 can be more firmly joined to each other.
(5) A disc 41 of a rotating machine according to a fifth aspect includes: the inner diameter-side member 71 that has an annular shape centered on the axis line O, and that forms a portion of the disc 41 on the radial inner side relative to the axis line O, and that is formed of the third material 83 having relatively low density and relatively low stiffness in the disc 41; and the outer diameter-side member 72 that forms a portion of the disc 41 on the radial outer side, and that is formed of the fourth material 84 having relatively high density and relatively high stiffness in the disc 41.

According to the above-described configuration, the inner diameter-side member 71 formed of the third material 83 having low density and low stiffness is provided, so that the inner diameter-side member 71 is likely to be deformed preferentially in a case where a rotational force is applied. Therefore, the circumferential stress that is borne by the inner diameter-side member 71 is reduced. Accordingly, the distribution of the circumferential stress in the radial direction is made uniform, and it is possible to reduce the weight of the entire disc 41 of a rotating machine.
(6) A disc 41 of a rotating machine according to a sixth aspect is the disc 41 of a rotating machine according to the fifth aspect, in which the third material 83 is the lattice structure 76 that includes a plurality of beams extending at least in the radial direction and the circumferential direction, and the fourth material 84 is a solid metal material.

According to the above configuration, by using the lattice structure 76 as the third material 83, it is possible to easily realize a reduction in density and a reduction in stiffness of the inner diameter-side member 71. In addition, by using a solid metal material as the fourth material 84, it is possible to easily realize an increase in density and an increase in stiffness of the outer diameter-side member 72.
(7) A rotating machine 1 according to the seventh aspect includes: the disc 41 of a rotating machine according to any one of the first to sixth aspects; a plurality of blades that extend toward a radial outer side from the disc 41 of a rotating machine and that are arranged in the circumferential direction; and the casing 62 that covers the blades from an outer periphery side.

According to the above configuration, since the disc 41 of a rotating machine having a reduced weight is provided, it is possible to realize a rotating machine that can be more stably and efficiently operated.

### INDUSTRIAL APPLICABILITY

The present disclosure relates to a disc of a rotating machine and a rotating machine, each of which has a lightweight structure.

### REFERENCE SIGNS LIST

1 . . . Turbofan engine
10 . . . Compressor
11 . . . Compressor rotor
12 . . . Compressor rotor blade
13 . . . Compressor casing
14 . . . Compressor stator vane
15 . . . Intake port
20 . . . Combustor
30 . . . Turbine
31 . . . Turbine rotor
32 . . . Turbine rotor blade
33 . . . Turbine casing
34 . . . Turbine stator vane
35 . . . Exhaust port
40 . . . Turbofan
41 . . . Disc
42 . . . Fan blade
43 . . . Disc main body
44 . . . Rib
50 . . . Duct
61 . . . Rotor
62 . . . Casing
71 . . . Inner diameter-side member
72 . . . Outer diameter-side member
73 . . . Joint
74 . . . Inner diameter-side lattice structure
75 . . . Joining portion
76 . . . Lattice structure
81 . . . First material
82 . . . Second material
83 . . . Third material
84 . . . Fourth material
91 . . . Intermediate lattice structure
92 . . . Base material for joining
101 . . . Radial beam
102 . . . Circumferential beam
F . . . Bypass flow path
O . . . Axis line

1. A disc of a rotating machine comprising:
an inner diameter-side member that has an annular shape centered on an axis line, that forms a portion of the disc on a radial inner side relative to the axis line, and that is formed of a first material having relatively high density and relatively high stiffness in the disc; and
an outer diameter-side member that is joined to a radial outer side with respect to the inner diameter-side member, and that is formed of a second material having relatively low density and relatively high stiffness in the disc.

2. The disc of a rotating machine according to claim 1, wherein the first material is a metal material, and the second material is a composite material that includes a fiber material and a base material impregnated with the fiber material.

3. The disc of a rotating machine according to claim 1, further comprising:
an inner diameter-side lattice structure that is joined further to a radial inner side of the inner diameter-side member, and that includes a plurality of beams extending at least in a radial direction and a circumferential direction.

4. The disc of a rotating machine according to claim 2, further comprising:
a joining portion that joins the inner diameter-side member and the outer diameter-side member to each other,
wherein the joining portion includes
an intermediate lattice structure that has a plurality of beams extending at least in a radial direction and a circumferential direction, and that is integrally joined to the inner diameter-side member, and
a base material for joining that is formed of the base material of the composite material forming the outer diameter-side member, and that fills voids in the intermediate lattice structure.

5. A disc of a rotating machine comprising:
an inner diameter-side member that has an annular shape centered on an axis line, that forms a portion of the disc on a radial inner side relative to the axis line, and that is formed of a third material having relatively low density and relatively low stiffness in the disc; and
an outer diameter-side member that forms a portion of the disc on a radial outer side, and that is formed of a fourth material having relatively high density and relatively high stiffness in the disc.

6. The disc of a rotating machine according to claim 5, wherein the third material is a lattice structure that includes a plurality of beams extending at least in a radial direction and a circumferential direction, and the fourth material is a solid metal material.

7. A rotating machine comprising:
a disc of a rotating machine according to claim 1;
a plurality of blades configured to extend toward a radial outer side from the disc of the rotating machine, and to be are arranged in a circumferential direction; and
a casing configured to cover the blades from an outer periphery side.
